(19) United States
(12) Patent Application Publication
(10) Pub. No.: US 2002/0079063 A1
(43) Pub. Date: Jun. 27, 2002

(54) Pleated shade

(76) Inventor: Terry A. Sheward, Newport Beach, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/746,568

(22) Filed: Dec. 21, 2000

(51) Int. Cl. E06B 3/48

(52) U.S. Cl. 160/84.04; 160/84.03

(57) ABSTRACT

A pleated window shade is disclosed having pleats that are uniform in appearance, that maintains its pleated shape over time in either a vertical or horizontal orientation, and is easy and inexpensive to manufacture. The shade is produced by running a flat segment of material over a serrated cutting wheel, which cuts a predetermined number of yarn segments at regular intervals. The cuts cause the material to fold or pleat along the axis of the cuts, resulting in a uniform, neat pleated appearance. The pleats may be made along the length of a roll of fabric to easily manufacture shades to cover large vertical spaces.

### BACKGROUND OF THE INVENTION

1. Field of the Invention

This invention relates to window coverings, and more specifically, to a pleated shade.

2. Description of the Related Art

Pleated window shades are well known in the industry. Typically, the pleats in the shade are introduced by heat-treating the material to form the pleats. Alternatively, the pleats can be sewn into the material using an independent segment of thread. Both of these methods of forming pleats are expensive and time-consuming. Undesirably, when pleats are placed in a vertical orientation, they often are not uniform in appearance. In addition, in the case of heat-treated pleats, over time fabric may return to its original, unpleated shape and not maintain the desired pleated appearance.

Although horizontal pleated shades and vertical blinds have been well known for many hears, recently consumers have requested the appearance of pleats in a vertical shade. Many windows and transparent doors in connection with which vertical shades are used run from the floor of a room to close to the ceiling. Thus, the distance over which the shade must be pleated is typically much longer than the distance required for pleats in horizontal shades. In the prior art, pleats were normally made along the width of a roll of fabric. However, this width often is not long enough to cover the entire window or door in the vertical direction. Thus, a method of pleating fabric along the length of a roll of fabric is needed. Moreover, with regard to prior art pleats, the length of the pleat to be made was often limited by the length of the pleating machine used. Again, this length often is not long enough to cover the entire vertical distance needed by the shade. As a result, an improved method of pleating fabric along the length of a roll of fabric is needed.

In view of the fact that the length of a roll of fabric is typically much longer than any window or door, by placing the pleats in a vertical orientation along the length of the fabric roll, a shade for vertical windows and doors can be manufactured from a single piece of fabric. As a result, two segments of fabric do not need to be sewn together in order to be long enough to cover the window or door.

Moreover, many prior art pleats tend to have an inherent bias toward the packed together or closed state. That is, when open, a shade may not uniformly lie flat across a window or door. This may result in the shade not uniformly draping, creating an unappealing look to the shade. Thus, an improved method of making pleats is needed in order to improve the appearance of pleats in either the horizontal or vertical direction. An improved pleated window shade is also needed in the industry.

### SUMMARY OF THE INVENTION

A pleated vertical window shade is disclosed having pleats that are uniform in appearance, that maintains its pleated shape over time, and is easy and inexpensive to manufacture. The shade comprises a fabric formed of woven yarn fibers, having a predetermined number of fibers cut along an axis, such that a fold along a hinge line provided by the uncut fibers is created, forming a pleat. Preferably, five of every eight fibers are cut to form the pleat. The yarn fibers are preferably vinyl coated, polyester and anti-microbial and anti-bacterial. Alternatively, the material used for the pleated shade may be a coated fabric, laminated fabric, plastic sheet or any other material known to those skilled in the art. A plurality of identical pleats can be formed in the fabric, using a serrated cutting wheel. To form multiple pleats in the fabric or other material, a plurality of cutting wheels arranged in parallel are used to make the cuts in the yarn fibers or to make indentations or perforations in whatever material is used. The fabric is preferably provided in a roll and the fabric is pleated along the length of the roll.

The shade can be provided in a single section, or alternatively, in two matching sections, that cover a window when in an uncollapsed position. Hangers can be attached between each pleat of the shade, which are then attached to support means. Control means, such as a pull rod or cord can be used to move the shade between a collapsed and an uncollapsed position.

In accordance with another embodiment of the invention, there is provided a method of creating a pleat in a fabric or other material. The method comprises cutting a predetermined number of yarn fibers, holes or perforations along an axis, such that a fold along a hinge line provided by the uncut fibers is created, forming a pleat in the fabric. Preferably, the cutting comprises cutting five of every eight yarn fibers, and uses a serrated cutting wheel. Multiple cutting wheels are used to create a plurality of pleats in the fabric. In addition, the number of yarn fibers cut can be varied dramatically as will be understood by those of skill in the art.

### BRIEF DESCRIPTION OF THE DRAWINGS

FIG. 1 is a partial perspective view of the vertical pleated shade disclosed herein.

FIG. 2 is an enlarged view of the vertical pleated shade of FIG. 1, showing the cuts made in the fabric to form the vertical pleats.

FIG. 3A is a perspective view of the cuts being made in the fabric of the shade.

FIG. 3B is a perspective view of multiple cutting wheels arranged in parallel to form multiple vertical pleats in a piece of fabric.

FIG. 4 is a perspective view of a vertical pleated shade of the present invention in two matching sections in an uncollapsed position.

FIG. 5 is a perspective view of a vertical pleated shade of the present invention having a single section in a collapsed position.

### DETAILED DESCRIPTION OF THE PREFERRED EMBODIMENT

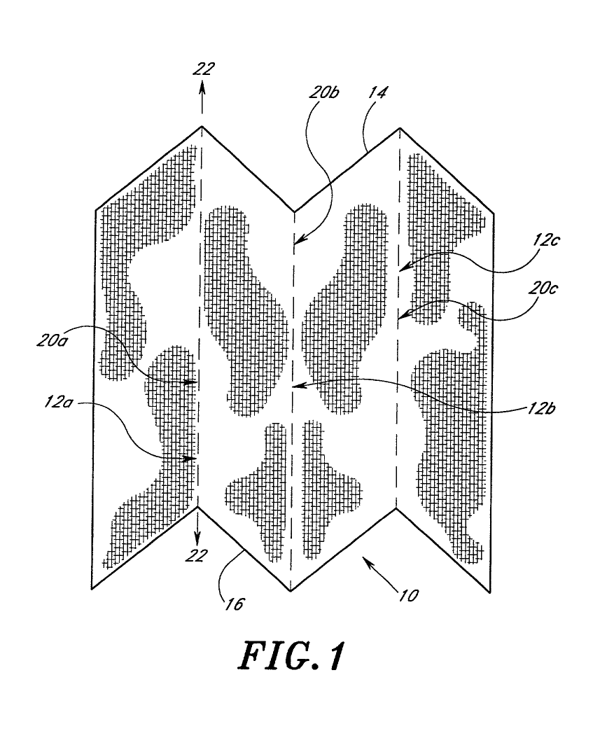

Turning now to FIG. 1, there is shown a partial perspective view of a vertical pleated window shade 10. The shade 10 is made of light filtering fabric, with fabric made of flame-resistant, vinyl coated yarns being preferred. The yarns are preferably polyester, but other known materials can also be used. The yarns are also preferably anti-microbial, anti-bacterial, and washable. The fabric can be of variable opacity to achieve a desired amount of room darkening when the shade 10 is closed. The pleated fabric of the shade 10 has strong, permanently set vertical pleats 12a, 12b, 12c which are capable of packing together tightly.

As an alternative to fabric, as will be understood by those skilled in the art, the present invention may be used with coated fabrics, laminated fabrics, plastic sheets or other materials. In the event that an alternative material is used, holes or perforations may be made in the material as opposed to cuts in yarn fibers.

In order to form the vertical pleats 12a, 12b, 12c in the shade material, a preselected number of yarn fibers are cut in a vertical direction 20a, 20b, 20c throughout the full height of the fabric from the top of the shade 14 to the bottom of the shade 16. By cutting a select number of yarn segments, the material maintains structural integrity but folds along the vertical axis 22 of the cuts, resulting in a plurality of pleats 12a, 12b, 12c. The cuts 20a, 20b, 20c create a sharp fold along a narrow hinge line provided by the remaining threads.

In a preferred embodiment, illustrated in FIG. 2, five of every eight yarn fibers are cut 24. This number can be varied of course. For example, three or four of every eight yam fibers, five or six of every ten yarn fibers, etc. can be cut, so long as the structural integrity of the material is maintained, and the cuts are sufficient to cause the material to fold along the vertical axis of the cuts 22. As will be understood by those of skill in the art, any percent of yarn fibers may be cut to accomplish the goal of the present invention.

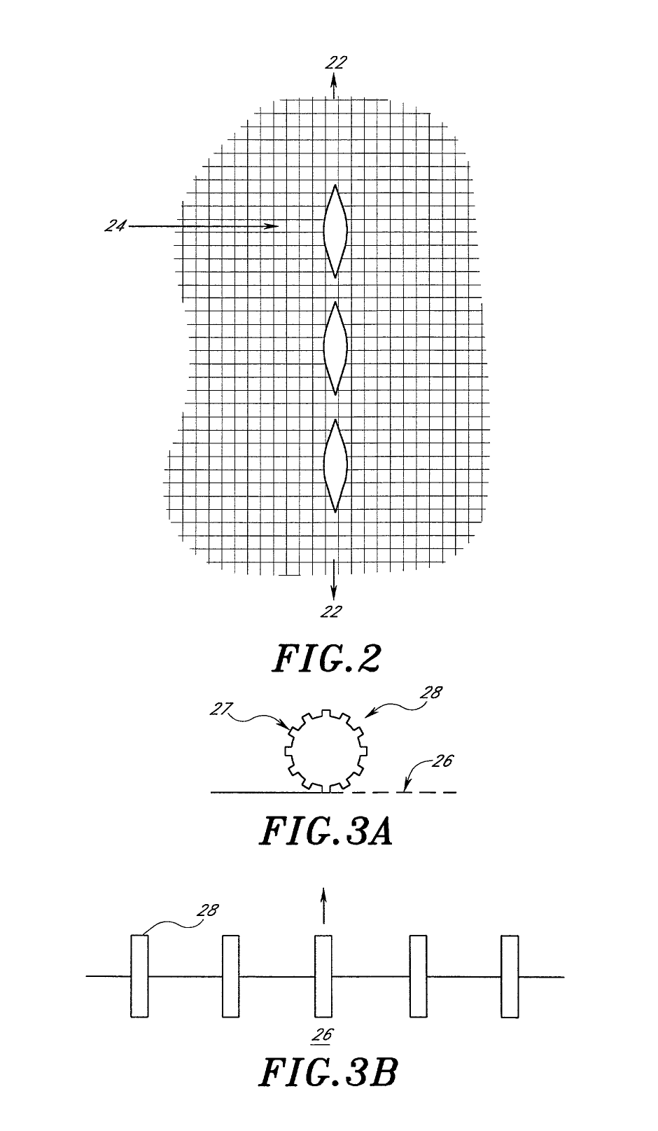

In a preferred embodiment, the cuts are made in the fabric by running a segment of the material 26 under a serrated cutting wheel 28, as illustrated in FIG. 3A. The blades 27 on the wheel 28 are sized and spaced apart so as to produce the desired length of cut in the desired spacing pattern. For example, the blades are long enough to cut five yarn fibers, and are spaced apart by a width of three fibers. As a result, five of every eighth fibers are cut as the wheel travels along the fabric.

As shown in FIG. 3B, multiple cutting wheels 28 can be positioned adjacent one another in parallel, and the fabric 26 run under the adjacent wheels, to produce a piece of fabric 26 that is cut along its vertical length in several parallel lines. The cutting wheels 28 are spaced apart from one another at widths that correspond to the distance between pleats desired in the final product. For example, two- or four-inch segments between pleats are common. To achieve the desired spacing, the cutting wheels 28 are spaced two or four inches apart.

The vertical pleated window shade can be produced to fit a variety of different window sizes. The desired width of the pleats are determined, and the fabric cut accordingly. Advantageously, when creating pleats in vertical shades, the pleats can be cut along the length of the fabric roll. Thus, the length of the shade is not restricted by the width of the fabric roll. As a result, shades of any desired length can be manufactured to cover windows and/or doors running from the floor to the ceiling of a room without the need for sewing two pieces of fabric together, as will be understood by those of skill in the art. For example, if pleats were cut along the width of a fabric roll and the width of the roll or the width of the pleating machine was 48″, but the window to be covered was 70″ from top to bottom, in order to obtain vertical pleats, two segments of the fabric would need to be sewn together to achieve vertical pleating. By cutting pleats along the length of the roll, the fabric roll far exceeds 70″ in length and a unitary piece of fabric can be used for the shade for the vertical window or door.

Of course, the present invention can be used to cut standard, horizontal pleats as well along the width of a fabric roll to quickly and easily create pleats without using the heat or sewing methods of the prior art. Thus, the method of creating pleats of the present invention is intended to be used for both horizontal and vertical pleats.

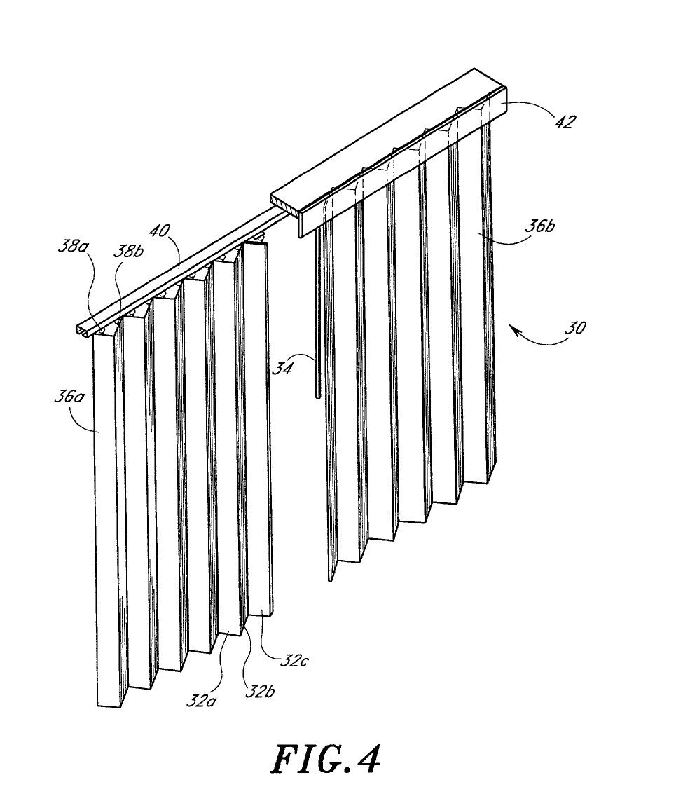

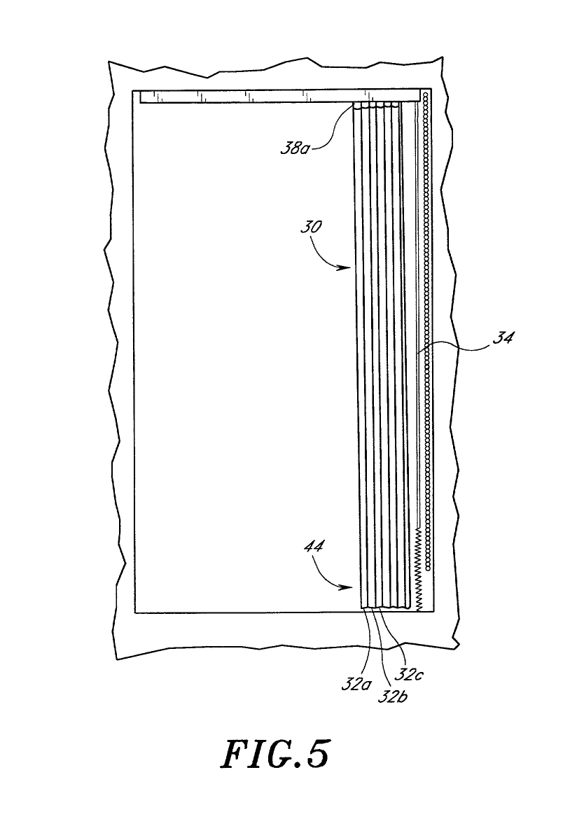

Turning now to FIGS. 4 and 5, there is shown a vertical pleated shade 30 as it would appear installed in an interior window. The shade 30 is sized so as to cover the window glass completely in its uncollapsed position (FIG. 4), yet in its collapsed position (FIG. 5), leave the window glass substantially uncovered. The shade 30 is collapsed by folding the pleats 32a, 32b, 32c accordion-fashion. When the shade 30 is drawn to a retracted position, the pleats 32a, 32b, 32c move to a tightly packed configuration 44, wherein the pleats 32a, 32b, 32c lie substantially flat against each other. Of course, shades are often used to cover a wide variety of things other than doors and windows. The pleated shades of the present invention may be used in many different applications including, but not limited to, shades which cover a section of a wall, shades which are used to divide a room and shades which are used as screens.

Conventional control means 34, such as a pull rod or cord can be used to extend the shade 30 fully across the window and to collapse it into its fully folded or stacked configuration 44. When the shade 30 is in the stacked position 44, it occupies a minimum of space along the side of the window to allow the widest possible view.

The window shade 30 can be provided in a single section (FIG. 5), or in two matching sections 36a, 36b as shown in FIG. 4, if desired. The two sections 36a, 36b cover the window when uncollapsed, and leave the window substantially uncovered when collapsed. Again, the sections 36a, 36b, are collapsed by folding the pleats 32a, 32b, 32c accordion-fashion to form a stack 44.

The window shade 30 can be installed in the window using any of a number of known methods. For example, as illustrated, conventional hangers 38a, 38b are attached to each segment of the shade 30 which is then attached to support means 40 which traverse the width of the window. Alternatively, a curtain rod (not shown) can be used. The rod extends between the vertical sides of the window above the top edge. A plurality of moveable support members, such a curtain rings, are carried thereon. The rings, in turn, support the window shade. The shade is attached to the curtain rings by any of a number of known methods, including conventional hangers. If desired, as shown in FIG. 4, a valence 42 can be formed around the support means 40, to hide it from view and make the window shade 30 more visually appealing. The improved shade of the present invention may be mounted by grommets or any other means known to those of skill in the art.

While the above detailed description has shown, described, and pointed out novel features of the invention as applied to various embodiments, it will be understood that various omissions, substitutions, and changes in the form and details of the invention illustrated may be made by those skilled in the art without departing from the spirit of the invention.

What is claimed is:

1. A pleated shade, comprising:
a fabric formed of woven yarn fibers, having a predetermined number of fibers cut along an axis, such that a fold along a hinge line provided by the uncut fibers is created, forming a pleat.

2. The pleated shade of claim 1, wherein the fabric is provided in a roll and the fabric is pleated along the length of the roll.

3. The pleated shade of claim 1, wherein the yarn fibers are vinyl coated.

4. The pleated shade of claim 1, wherein the yarn fibers are polyester.

5. The pleated shade of claim 1, wherein the yarn fibers are anti-microbial and anti-bacterial.

6. The pleated shade of claim 1, wherein a plurality of identical pleats are formed in the fabric.

7. The pleated shade of claim 1, wherein the cuts are made using a serrated cutting wheel.

8. The pleated shade of claim 6, wherein a plurality of cutting wheels arranged in parallel are used to make the cuts in the yarn fibers.

9. The pleated shade of claim 1, wherein the predetermined number is five of every eight fibers.

10. The pleated shade of claim 1, wherein the shade is provided in two matching sections that cover a window when in an uncollapsed position.

11. The pleated shade of claim 1, further comprising hangers attached to each pleat of the shade.

12. The pleated shade of claim 1, further comprising support means to which the hangers are attached.

13. The pleated shade of claim 1, further comprising control means to move the shade between a collapsed and an uncollapsed position.

14. A method of creating a pleat in a fabric, comprising:
cutting a predetermined number of yarn fibers along an axis, such that a fold along a hinge line provided by the uncut fibers is created, forming a pleat in the fabric.

15. The method of claim 14, wherein the pleats are created along the length of a roll of fabric.

16. The method of claim 14, wherein the cutting comprises cutting five of every eight yarn fibers.

17. The method of claim 14, wherein the cutting is done using a serrated cutting wheel.

18. The method of claim 16, wherein multiple cutting wheels are used to create a plurality of pleats in the fabric.

19. A pleated shade, comprising:
a material having a predetermined number of perforations therethrough along an axis to form a hinge line in said material, forming a pleat.

20. The shade of claim 19, wherein said material is a plastic.
